(19) United States
(12) Patent Application Publication
(10) Pub. No.: US 2003/0192239 A1
(43) Pub. Date: Oct. 16, 2003

(54) Planter pot with air pruning

(76) Inventor: Mark A. Rogers, Lisarow (AU)

Correspondence Address: Jacobson & Johnson, Suite 285, One West Water Street, St. Paul, MN, 55107-2080, US

(21) Appl. No.: 10/404,696

(22) Filed: Mar. 31, 2003

(30) Foreign Application Priority Data
Apr. 16, 2002 (AU) PS1751

(51) Int. Cl. A01G 9/02

(52) U.S. Cl. 47/65.5

(57) ABSTRACT

There is a pot for growing a plant. The pot in a position of use has downwardly opening gaps (6) through the side walls (4). The tips of plant roots growing down the side walls are pruned by the effects of air and light when encountering the gaps (6) so that further up the root lateral growth inward toward centre of the pot is encouraged. The pot also has a substantially open bottom 2 and tapered side walls (4) to creat a wedging action to help soil retention above the open bottom (2).

### FIELD OF THE INVENTION

This invention relates to horticultural products. More particularly it discloses an improved planter pot.

### BACKGROUND OF THE INVENTION

Seedlings when grown in prior art solid walled planter pots often develop root curl. The plant roots initially tend to grow laterally until they encounter the sides of the pot. They then continue downward along the sides to the bottom where they grow in a circular fashion around the inside of the pot. This results in a dense root ball which is difficult if not impossible to spread when the plant is subsequently placed in the ground. Root curl slows down the development of plants after placement in the ground and also reduces the ability of the roots to anchor the plant against wind. Many plants can only be left in conventional pots for about 3 months before unacceptable root curl occurs.

### SUMMARY OF THE INVENTION

It is therefore an object of this invention to ameliorate the aforementioned disadvantages. Accordingly a pot for growing a plant is disclosed, said pot in a position of use having one or more downwardly opening gaps through the sides thereof intermediate the bottom and upper rim whereby the tips of plant roots growing down said sides are pruned by the effects of air and light when encountering said one or more gaps so that further up the root lateral growth inwardly toward the centre of the pot is thereby encouraged.

Preferably the pot bottom is substantially open whereby those plant roots encountering said bottom are also pruned against root curl growth by the effects of air and light.

It is further preferred that the cross-sectional area of the pot tapers inwardly from the top to create a wedging action which assists in retaining soil in said pot above the open bottom and also enables said pot to be stacked in another similar pot when not in use.

### BRIEF DESCRIPTION OF THE DRAWINGS

The currently preferred form of the invention will now be described with reference to the attached drawings in which:

FIG. 1 is an elevation view of a planter pot constructed according to this concept.

FIG. 2 is a plan view of the pot of FIG. 1.

FIG. 3 is a vertical cross-sectional view along the lines A-A of FIG. 2, and

FIG. 4 is a cross-sectional elevation view showing the planter pot of FIG. 1 stacked in another similar planter pot.

### DELAILED DESCRIPTION OF THE PREFERRED EMBODIMENT

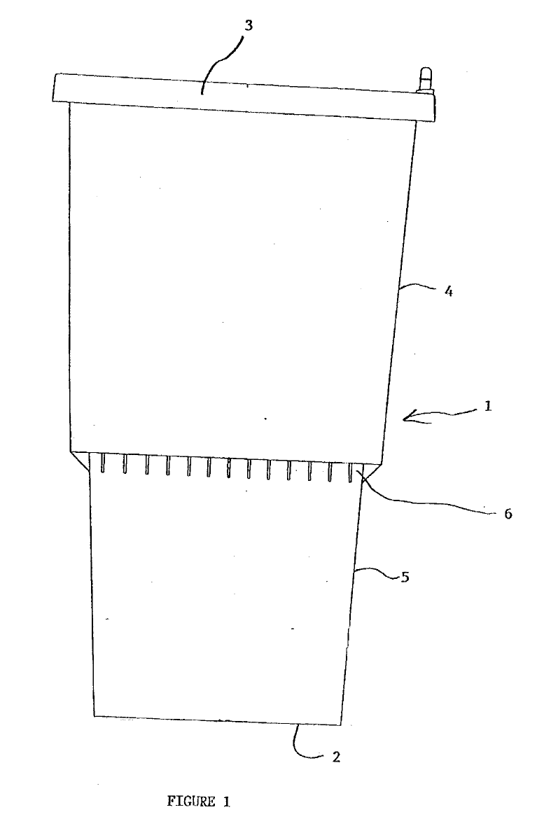

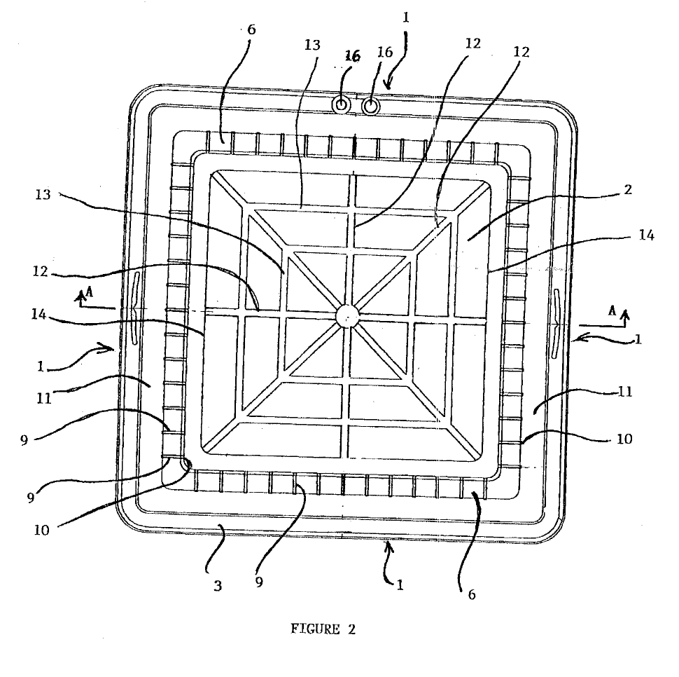

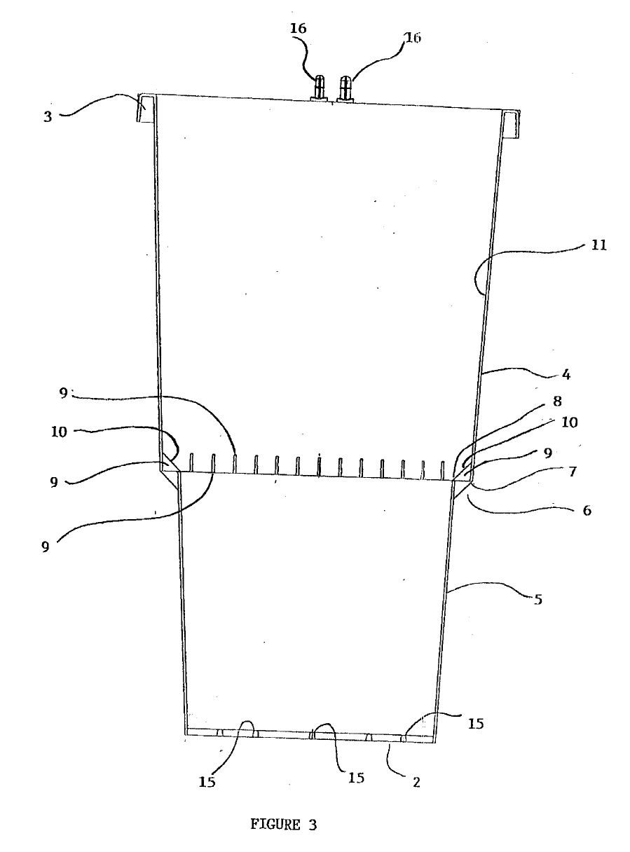

Referring first to FIGS. 1 and 2 the pot with this embodiment is square and has four idential tapered side walls (indicated generally as 1) which extend between the bottom 2 and the upper rim 3. Each side wall comprises upper and lower sections 4 and 5. While the upper and lower sections making up each side wall lie in parallel planes as best shown by FIGS. 1 and 3 the upper section 4 is spaced outwardly from the lower section 5 to form a downwardly directed gap 6. With this embodiment the adjacent edges 7 and 8 of the upper and lower sections are also aligned horizontally. The above structure occurs at the same height for each of the side walls so that the gap 6 is formed continuously around the periphery of the pot slightly below the mid-section. While the gap 6 with this embodiment is horizontal and about 6 mm wide the position, width and orientation may be changed according to design preference without departing from the scope of the invention.

The wall sections 4 and 5 are preferably joined by ribs 9 which bridge the gap 6 at spaced apart locations. While it is not essential to the invention each rib as shown in FIG. 3 may be in the shape a parallelegram which is inclined upwardly from the lower section 5 to connect with an adjacent portion of the upper section 4. In a variation to the embodiment shown the upper edges 10 of these ribs may also merge into vertical ridges which extend up the inside surface 11 of the upper section 4 to act a root guides. These ridges may protude out from said inside surface about 2 mm

As will be noted from FIG. 2 the bottom 2 is substantially open with only relatively narrow cross-members 12 and tie bars 13 provided to brace the side walls 1 against deflection. Preferably the side walls of the pot also merge smoothly into the edges 14 of the open bottom to avoid any surfaces which could deflect downwardly growing root tips into a spiral pattern The upper edges 15 of the cross-members and the tie bare are preferably bevelled to further eliminate any upwardly deflecting surfaces

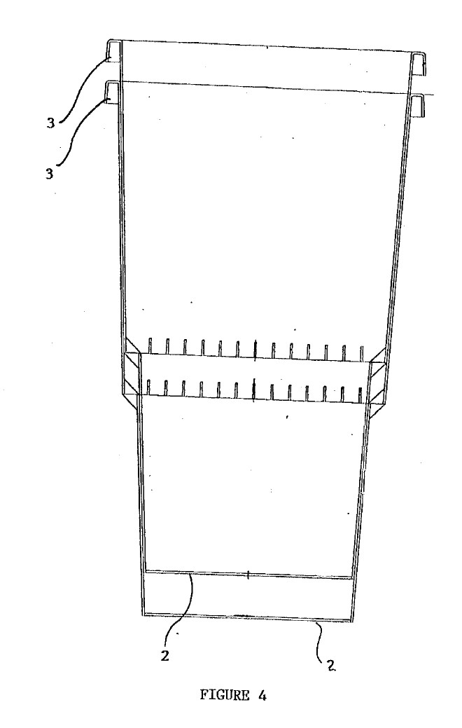

The four side walls with this embodiment taper inwardly as shown toward the bottom of the pot. The taper is about 3 to the vertical. This causes a wedging action which as mentioned earlier assists soil retention above the open bottom and also facilitates stacking of unused pots as shown in FIG. 4.

In use the pot is filled with soil or other potting material and is preferably placed on an open mesh support or an elevatecd rack (not shown) to ensure that the bottom and sides are exposed to air and light. As the plant grows the root tips initially tend to spread outwardly and then downwardly along the inside surface 11 of the upper wall section 4. Upon reaching the gap 6 however the root tips are pruned by the effects of air and light. Further downward growth along the side walls is thereby inhibited with the result that inwardly and downwardly directed lateral development occurs further up the root. Those root tips which eventually reach the open bottom of the pact are similarly pruned by air and light before root curl can occur and subsequent lateral growth is thus again encouraged further up the root. The result is a healthier root system and a more robust plant which is better adapted for transplanting into the ground.

Although not essential to the invention the embodiment shown may also be provided with integral spray nozzles 16 which are formed in the rim of the pot. These, upon connection to a water supply (not shown), are adapted to direct a spray pattern across the soil in the pot.

It will thus be appreciated that this invention at least in the form of the example described provides a novel and improved planter pot. Clearly however the example disclosed is only the currently preferred form of the invention and a wide variety of modifications may be made which would be apparent to a person skilled in the art. For example the number, placement and orientation of the gaps in the side walls may be changed according to design preference. The shape of the pot may also be changed from the square cross-section shown to other configurations such as round or oval etc. Although it is currently preferred to mould the pot from plastic such as polypropylene other materials and methods of manufacture may be used within the scope of the invention.

I claim:

1. A pot for growing a plant, said pot when in a position of use having one or more downwardly opening gaps through side walls intermediate the bottom and upper rim thereof whereby the tips of plant roots growing down said side walls are pruned by the effects of air and light when encountering said one or more gaps.

2. The pot as claimed in claim 1 wherein said downwardly directed gaps are formed around the periphery of the pot.

3. The pot as claimed in claim 1 wherein said side walls include upper and lower sections with said upper sections being spaced outwardly from said lower sections to form said gaps.

4. The pot as claimed in claim 1 wherein the gaps are bridged by ribs at spaced apart locations along said gaps.

5. The pot as claimed in claim 1 wherein the bottom thereof is substantially open.

6. The pot as claimed in claim 1 wherein the cross-sectional area of the pot tapers inwardly toward the bottom to cause a wedging action which assists soil retention above said bottom.

7. The pot as claimed in claim 3 wherein vertical ridges extend along the inside surfaces of said upper sections to act as root guides.

8. The pot as claimed in claim 1 wherein said gaps are substantially horizontal.

9. The pot as claimed in claim 1 wherein the rim of said pot is fitted with spray nozzles.
